(19) United States
(12) Patent Application Publication
(10) Pub. No.: US 2017/0022945 A1
(43) Pub. Date: Jan. 26, 2017

(54) ENGINE SYSTEM AND METHOD OF CONTROLLING THE SAME

(71) Applicant: HYUNDAI MOTOR COMPANY, Seoul (KR)

(72) Inventor: Hyun KIM, Hwaseong-si (KR)

(21) Appl. No.: 14/945,365

(22) Filed: Nov. 18, 2015

(30) Foreign Application Priority Data
Jul. 20, 2015 (KR) 10-2015-0102668

(51) Int. Cl. F02M 31/02

(52) U.S. Cl. CPC F02M 31/02

(57) ABSTRACT

An engine system includes a plurality of injectors disposed at each of one or more combustion chambers of an engine in order to inject a fuel, a plurality of heaters that heat the fuel to be injected from the plurality of injectors, and a controller that determines whether a temperature of external air or a temperature of coolant is less than a predetermined temperature when a starting condition is satisfied, and that operates the plurality of heaters if the temperature of external air or the temperature of coolant is less than the predetermined temperature, wherein the controller compares a heating time that heats fuel with operation of the plurality of heaters with a first predetermined time, and operates the plurality of injectors to inject fuel if the heating time is greater than the first predetermined time.

### CROSS-REFERENCE TO RELATED APPLICATION

This application claims the benefit of priority to Korean Patent Application No. 10-2015-0102668, filed with the Korean Intellectual Property Office on Jul. 20, 2015, the entire contents of which are incorporated herein by reference.

### TECHNICAL FIELD

The present disclosure relates to an engine system and a method of controlling the engine system that can improve startability by heating fuel that is injected from an injector, when a temperature of external air or a temperature of coolant is low.

### BACKGROUND

Due to high oil prices, energy security, and exhaust gas emission regulations, interest in biofuels have gradually increased and a spread of biofuels has been rapid.

In bioethanol, a production cost has lowered and CO₂ reduction effect (40% level of gasoline) has increased and thus, a use thereof has gradually increased. Particularly, in South America, a use amount of Flexible-Fuel Vehicles (FFV) using ethanol fuel as main fuel has increased to about 75%.

However, in fuel of ethanol 100%, due to a high ignition point and a vapor pressure (40 kPa or less) lower than that of gasoline (55 kPa to 70 kPa), in a low temperature condition of external air, particularly in a winter season, a cold startability problem of an engine may occur.

As a method for enhancing cold startability of an engine of the FFV, there is a method of using gasoline fuel as starting fuel. That is, an engine system of a conventional FFV includes an auxiliary fuel tank system that stores and supplies additional fuel for cold starting of an engine.

FIG. 3 is a block diagram illustrating an engine system of a conventional FFV.

As shown in FIG. 3, the engine system of a conventional FFV may include an engine control unit (ECU) 10, an ethanol fuel tank 20, an ethanol pump 22, a plurality of ethanol injectors 22a, 22b, 22c, and 22d, a gasoline fuel tank 30, a gasoline pump 32, and a gasoline injector 34.

The gasoline injector 34 is disposed at an intake passage to inject gasoline fuel to cylinders, and the plurality of ethanol injectors 22a, 22b, 22c, and 22d inject ethanol fuel to each cylinder. The gasoline pump 32 pumps gasoline fuel that is stored at the gasoline fuel tank 30 to supply the gasoline fuel to the gasoline injector 34, and the ethanol pump 22 pumps ethanol fuel that is stored at the ethanol fuel tank 20 to supply the ethanol fuel to the plurality of ethanol injectors 22a, 22b, 22c, and 22d. When a temperature of external air is equal to or less than a predetermined temperature, gasoline fuel is injected as the starting fuel from the gasoline injector 34.

In order to enhance cold starting, because a conventional FFV using gasoline fuel as auxiliary fuel should additionally mount additional components including a fuel tank for storing gasoline fuel, a fuel cap, a fuel pump, a bracket, and a fuel line, the conventional FFV is disadvantageous in view of weight, cost, and assembly productivity of the vehicle.

Further, as additional space must be secured within a small engine compartment, there is a problem of inconvenience, an increase of a fuel cost, and a fire danger upon fuelling (spilling fuel to an engine room).

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to provide an engine system and a method of controlling the same having advantages of being capable of improving startability by heating fuel that is injected from an injector when a temperature of external air or a temperature of coolant is low.

An exemplary embodiment of the present disclosure provides an engine system including: a plurality of injectors that are disposed to each of combustion chambers of an engine in order to inject fuel; a plurality of heaters that heat fuel to be injected from the plurality of injectors; and a controller that determines whether a temperature of external air or a temperature of coolant is less than a predetermined temperature when a starting condition is satisfied, and that operates the plurality of heaters if the temperature of external air or the temperature of coolant is less than the predetermined temperature, wherein the controller compares a heating time that heats fuel with operation of the plurality of heaters with a first predetermined time, and operates the plurality of injectors to inject fuel, if the heating time is greater than the first predetermined time.

When the controller determines that at least one of the plurality of heaters is failed, the controller may prohibit fuel injection of the injector corresponding to the failed heater.

The controller may compare an elapsed time from a time point at which the starting condition is satisfied with a second predetermined time and may operate an injector corresponding to the failed heater to inject fuel if the elapsed time is greater than the second predetermined time.

The controller may determine whether a heating release condition is satisfied when the plurality of heaters are operating, and may stop operation of the plurality of heaters if the heating release condition is satisfied.

The heating release condition may be satisfied if the temperature of coolant is greater than or equal to the predetermined temperature.

The heating release condition may be satisfied if the heating time is greater than or equal to a threshold time.

The plurality of heaters may be mounted in the plurality of injectors, respectively.

The plurality of heaters may be mounted in a plurality of fuel supply lines supplying fuel to the plurality of injectors, respectively.

The engine system may further include: a fuel tank that stores fuel; and a fuel pump that pumps fuel that is stored at the fuel tank to the plurality of injectors, wherein the fuel may include ethanol.

Another embodiment of the present disclosure provides a method of controlling an engine system including a plurality of injectors and a plurality of heaters including: determining, when a starting condition is satisfied, whether a temperature of external air or a temperature of coolant is less than a predetermined temperature; operating, if the temperature of external air or the temperature of coolant is less than the predetermined temperature, the plurality of heaters to heat fuel to be injected from the plurality of injectors; comparing a heating time in which fuel is heated with operation of the plurality of heaters with a first predetermined time; and operating, if the heating time is greater than the first predetermined time, the plurality of injectors to inject fuel.

The method may further include: determining whether the plurality of heaters are failed; prohibiting, if at least one of the plurality of heaters is failed, fuel injection of an injector corresponding to the failed heater; comparing an elapsed time from a time point at which the starting condition is satisfied with a second predetermined time; and operating, if the elapsed time is greater than the second predetermined time, the injector corresponding to the failed heater to inject fuel.

The method may further include: determining, when the plurality of heaters are operating, whether a heating release condition is satisfied; and stopping, if the heating release condition is satisfied, operation of the plurality of heaters.

The heating release condition may be satisfied if the temperature of coolant is greater than or equal to the predetermined temperature.

The heating release condition may be satisfied if the heating time is greater than or equal to a threshold time.

The plurality of heaters may be mounted in the plurality of injectors, respectively.

The plurality of heaters may be mounted in a plurality of fuel supply lines supplying fuel to the plurality of injectors, respectively.

The fuel may include ethanol.

### BRIEF DESCRIPTION OF THE DRAWINGS

FIG. 1 is a block diagram illustrating a configuration of an engine system according to an exemplary embodiment of the present disclosure.

FIG. 2 is a flowchart illustrating a method of controlling an engine system according to an exemplary embodiment of the present disclosure.

FIG. 3 is a block diagram illustrating an engine system of a conventional Flexible-Fuel Vehicle (FFV).

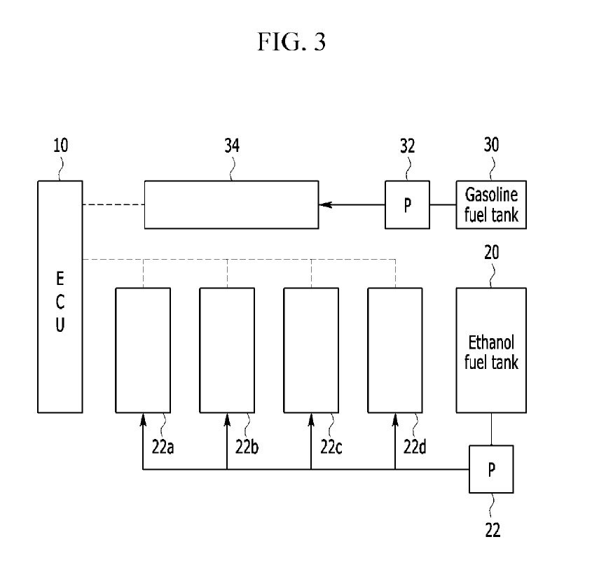

### DETAILED DESCRIPTION

An exemplary embodiment of the present disclosure will hereinafter be described in detail with reference to the accompanying drawings.

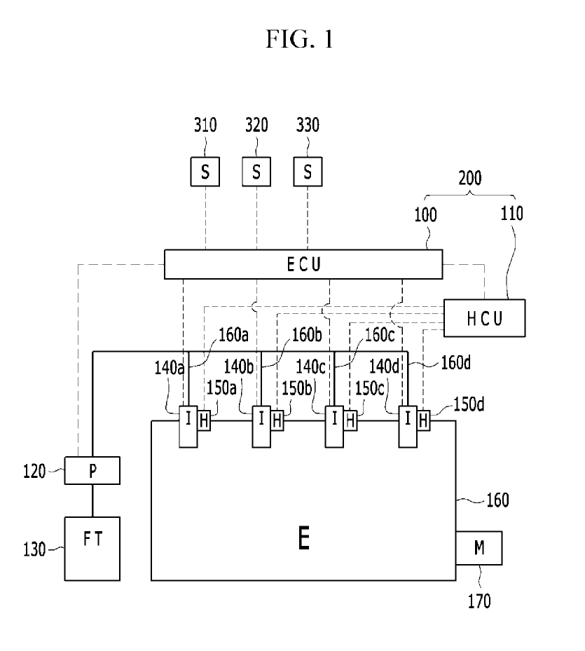

FIG. 1 is a block diagram illustrating a configuration of an engine system according to an exemplary embodiment of the present disclosure.

As shown in FIG. 1, an engine system according to an exemplary embodiment of the present disclosure may include an engine 160, an engine control unit 100, a heater control unit 110, a fuel tank 130, a fuel pump 120, a plurality of injectors 140a, 140b, 140c, and 140d, a plurality of heaters 150a, 150b, 150c, and 150d, and a start motor 170.

In the fuel tank 130, a fuel is stored. The fuel may be ethanol, and a vehicle to which the engine system is applied may be a Flexible-Fuel Vehicle (FFV) using ethanol as fuel.

The fuel pump 120 pumps fuel that is stored in the fuel tank 130 to the plurality of injectors 140a, 140b, 140c, and 140d. The fuel pump 120 may be disposed at the inside or the outside of the fuel tank 130.

The first, second, third, and fourth injectors 140a, 140b, 140c, and 140d are disposed at each combustion chamber of the engine 160 and inject fuel that is pumped from the fuel pump 120 according to predetermined timing. As injected fuel is mixed with air and is burned in the combustion chamber, a torque of the engine 160 may be generated.

The first, second, third, and fourth heaters 150a, 150b, 150c, and 150d may be disposed to correspond to the first, second, third, and fourth injectors 140a, 140b, 140c, and 140d, respectively and may heat fuel to be injected from the first, second, third, and fourth injectors 140a, 140b, 140c, and 140d, respectively. The first, second, third, and fourth heaters 150a, 150b, 150c, and 150d may be mounted in the first, second, third, and fourth injectors 140a, 140b, 140c, and 140d, respectively. Alternatively, the first, second, third, and fourth heaters 150a, 150b, 150c, and 150d may be mounted in first, second, third, and fourth fuel supply lines 160a, 160b, 160c, and 160d that supply fuel to the first, second, third, and fourth injectors 140a, 140b, 140c, and 140d, respectively. Hereinafter, a case in which the first, second, third, and fourth heaters 150a, 150b, 150c, and 150d are mounted in the first, second, third, and fourth injectors 140a, 140b, 140c, and 140d, respectively, is illustrated.

According to an exemplary embodiment of the present disclosure, when a temperature of external air or a temperature of coolant that circulates throughout the engine 160 is equal to or less than a predetermined temperature, by operating each of the first, second, third, and fourth heaters 150a, 150b, 150c, and 150d for a predetermined time, a temperature of a fuel to be injected from the first, second, third, and fourth injectors 140a, 140b, 140c, and 140d may increase.

When a temperature of external air or a temperature of coolant is equal to or less than a predetermined temperature and when one of the first, second, third, and fourth heaters 150a, 150b, 150c, and 150d has become inoperable, fuel that is injected from an injector in which the failed heater is disposed may not be burned. When the unburned fuel remains in the combustion chamber, an air/fuel ratio may be rich and combuststability may be deteriorated upon starting by the unburned fuel.

Therefore, in an exemplary embodiment of the present disclosure, when an ignition switch is turned on, in an injector in which the failed heater is disposed, fuel is not injected for a predetermined time, and in an injector in which a normally operating heater is disposed, by injecting fuel, combuststability may be enhanced upon starting.

For example, if the first heater 150a of the first, second, third, and fourth heaters 150a, 150b, 150c, and 150d fails to operate, for the predetermined time after starting, fuel may be not injected from the first injector 140a but fuel may be injected from the second, third, and fourth injectors 140b, 140c, and 140d. After the predetermined time has elapsed, when the engine 160 is warmed up, fuel is normally injected even from the first injector 140a. A method of determining a failure of the first, second, third, and fourth heaters 150a, 150b, 150c, and 150d is well-known in the art and thus in this specification, a detailed description thereof will be omitted.

When the ignition switch is turned on, the start motor 170 may perform an engine cranking operation.

A method of controlling an engine system according to an exemplary embodiment of the present disclosure may be performed by the engine control unit 100 and/or the heater control unit 110. The engine control unit 100 controls an entire operation of an engine system, and the heater control unit 110 may control operation of the first, second, third, and fourth heaters 150a, 150b, 150c, and 150d.

For such an object, the engine control unit 100 and the heater control unit 110 may be implemented with at least one microprocessor operating by a predetermined program, and the predetermined program may be programmed to perform each step of a method of controlling an engine system according to an exemplary embodiment of the present disclosure.

Some processes of a method of controlling an engine system according to an exemplary embodiment of the present disclosure, to be described later, may be performed by the engine control unit 100, and some other processes may be performed by the heater control unit 110. Therefore, a method of controlling an engine system according to an exemplary embodiment of the present disclosure may use the engine control unit 100 and the heater control unit 110 as one controller 200, and in this specification, the engine control unit 100 and the heater control unit 110 are referred to as the controller 200.

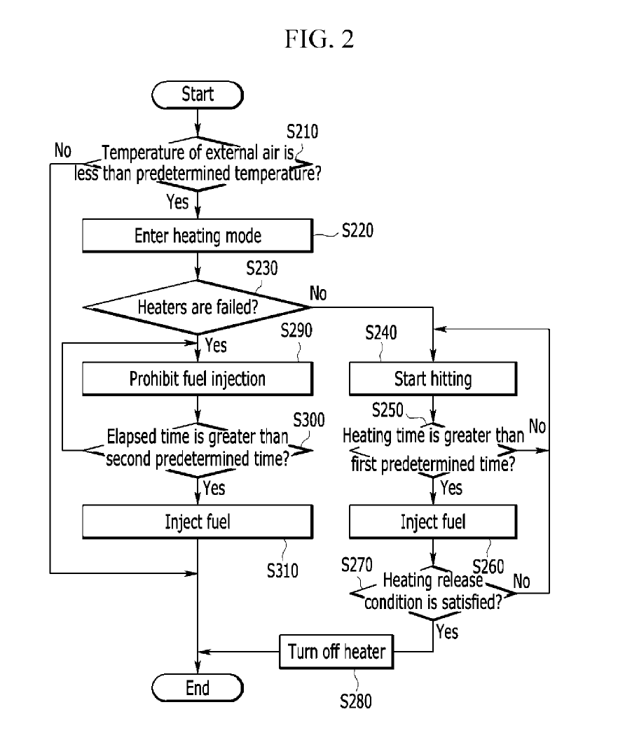

FIG. 2 is a flowchart illustrating a method of controlling an engine system according to an exemplary embodiment of the present disclosure.

As shown in FIG. 2, when a starting condition is satisfied, a method of controlling an engine system according to an exemplary embodiment of the present disclosure may be started. An ignition switch sensor 310 may detect an on or off position of an ignition switch and output a detection signal thereof to the controller 200. When the ignition switch is turned on, the controller 200 may determine that the starting condition is satisfied.

The controller 200 determines whether a temperature of external air or a temperature of a coolant is less than a predetermined temperature (S210). An external air temperature sensor 320 may detect the temperature of external air and output a detection signal thereof to the controller 200. A coolant temperature sensor 330 may detect the temperature of coolant and output a detection signal thereof to the controller 200.

If the temperature of external air or the temperature of coolant is greater than or equal to the predetermined temperature at step S210, a method of controlling an engine system according to an exemplary embodiment of the present disclosure is ended. In this case, the controller 200 may not operate the first, second, third, and fourth heaters 150a, 150b, 150c, and 150d.

If the temperature of external air or the temperature of coolant is less than the predetermined temperature at step S210, the process enters a heating mode (S220).

In the heating mode, the controller 200 may determine whether the first, second, third, and fourth heaters 150a, 150b, 150c, and 150d are operable, or have failed (S230).

If the first, second, third, and fourth heaters 150a, 150b, 150c, and 150d are in a normal state at step S230, the controller 200 may operate the first, second, third, and fourth heaters 150a, 150b, 150c, and 150d to heat fuel to be injected from the first, second, third, and fourth injectors 140a, 140b, 140c, and 140d (S240).

The controller 200 may compare a heating time that heats fuel by operating the first, second, third, and fourth heaters 150a, 150b, 150c, and 150d with a first predetermined time (S250).

If the heating time is equal to or less than the first predetermined time at step S250, the controller 200 may continuously operate the first, second, third, and fourth heaters 150a, 150b, 150c, and 150d.

If the heating time is greater than the first predetermined time at step S250, the controller 200 may operate the first, second, third, and fourth injectors 140a, 140b, 140c, and 140d, to inject fuel (S260).

When the first, second, third, and fourth heaters 150a, 150b, 150c, and 150d are operating, the controller 200 determines whether a heating release condition is satisfied (S270). When the temperature of coolant is greater than or equal to the predetermined temperature or when the heating time is greater than or equal to a threshold time, the heating release condition may be satisfied.

If the heating release condition is not satisfied at step S270, by continuing to operate the first, second, third, and fourth heaters 150a, 150b, 150c, and 150d, the controller 200 may continue to heat fuel that is injected from the first, second, third, and fourth injectors 140a, 140b, 140c, and 140d.

If the heating release condition is satisfied at step S270, the controller 200 may stop operation of the first, second, third, and fourth heaters 150a, 150b, 150c, and 150d (S280).

If any one of the first, second, third, and fourth heaters 150a, 150b, 150c, and 150d is failed, or inoperable, at step S230, the controller 200 may prohibit fuel injection of an injector in which the failed, or inoperable, heater is mounted (S290). For example, if the first heater 150a of the first, second, third, and fourth heaters 150a, 150b, 150c, and 150d is failed, or inoperable, the controller 200 may prohibit fuel injection of the first injector 140a. In this case, the second, third, and fourth heaters 150b, 150c, and 150d and the second, third, and fourth injectors 140b, 140c, and 140d of a normal state may be controlled through step S240 to S280.

The controller 200 may compare an elapsed time from a time point at which the starting condition is satisfied with a second predetermined time (S300).

If the elapsed time is equal to or less than the second predetermined time at step S300, the controller 200 may continuously prohibit fuel injection of the injector in which the failed, or inoperable, heater is disposed.

If the elapsed time is greater than the second predetermined time at step S300, the controller 200 may inject fuel by operating an injector in which the failed, or inoperable, heater is disposed (S310). That is, after the starting condition is satisfied, when the engine 160 is warmed up, even in the injector in which the failed, or inoperable, heater is disposed, fuel is normally injected.

In short, the controller 200 operates the first, second, third, and fourth heaters 150a, 150b, 150c, and 150d based on the temperature of external air or the temperature of coolant. If at least one of the first, second, third, and fourth heaters 150a, 150b, 150c, and 150d is failed, or inoperable, the controller 200 operates normal heaters, except for the failed, or inoperable, heater.

If a heating time in which fuel is heated by operating normal heaters is greater than the first predetermined time, in injectors in which normal heaters are mounted, fuel is normally injected and the engine is thus started.

If an elapsed time from a time point in which the starting condition is satisfied is greater than the second predetermined time, an injector in which the failed, or inoperable, heater is mounted normally injects fuel and thus an entire injector is normally operated.

As described above, according to an exemplary embodiment of the present disclosure, when a temperature of external air or a temperature of coolant is low, by heating fuel to be injected from an injector, cold startability can be improved.

Further, in an injector in which a failed, or inoperable, heater is mounted, by not injecting fuel for the second predetermined time, combustion stability can be prevented from being deteriorated.

While this disclosure has been described in connection with what is presently considered to be practical exemplary embodiments, it is to be understood that the disclosure is not limited to the disclosed embodiments, but, on the contrary, is intended to cover various modifications and equivalent arrangements included within the spirit and scope of the appended claims.

What is claimed is:

1. An engine system, comprising:
a plurality of injectors disposed at each of one or more combustion chambers of an engine in order to inject a fuel;
a plurality of heaters that heat the fuel to be injected from the plurality of injectors; and
a controller that determines whether a temperature of external air or a temperature of coolant is less than a predetermined temperature when a starting condition is satisfied, and that operates the plurality of heaters if the temperature of external air or the temperature of coolant is less than the predetermined temperature,
wherein the controller compares a heating time that heats fuel with operation of the plurality of heaters with a first predetermined time, and operates the plurality of injectors to inject fuel if the heating time is greater than the first predetermined time.

2. The engine system of claim 1, wherein when the controller determines that at least one of the plurality of heaters has failed, the controller prohibits fuel injection of an injector corresponding to the failed heater.

3. The engine system of claim 2, wherein the controller compares an elapsed time from a time point at which the starting condition is satisfied with a second predetermined time, and operates the injector corresponding to the failed heater to inject fuel if the elapsed time is greater than the second predetermined time.

4. The engine system of claim 1, wherein the controller determines whether a heating release condition is satisfied when the plurality of heaters are operating, and stops operation of the plurality of heaters if the heating release condition is satisfied.

5. The engine system of claim 4, wherein the heating release condition is satisfied if the temperature of coolant is greater than or equal to the predetermined temperature.

6. The engine system of claim 4, wherein the heating release condition is satisfied if the heating time is greater than or equal to a threshold time.

7. The engine system of claim 1, wherein the plurality of heaters are mounted in the plurality of injectors, respectively.

8. The engine system of claim 1, wherein the plurality of heaters are mounted in a plurality of fuel supply lines supplying fuel to the plurality of injectors, respectively.

9. The engine system of claim 1, further comprising:
a fuel tank that stores fuel; and
a fuel pump that pumps fuel that is stored in the fuel tank to the plurality of injectors,
wherein the fuel comprises ethanol.

10. A method of controlling an engine system comprising a plurality of injectors and a plurality of heaters, the method comprising:
determining, when a starting condition is satisfied, whether a temperature of external air or a temperature of coolant is less than a predetermined temperature;
operating, if the temperature of external air or the temperature of coolant is less than the predetermined temperature, the plurality of heaters to heat fuel to be injected from the plurality of injectors;
comparing a heating time in which fuel is heated with operation of the plurality of heaters with a first predetermined time; and
operating, if the heating time is greater than the first predetermined time, the plurality of injectors to inject fuel.

11. The method of claim 10, further comprising:
determining whether the plurality of heaters have failed;
prohibiting, if at least one of the plurality of heaters has failed, fuel injection of an injector corresponding to the failed heater;
comparing an elapsed time from a time point at which the starting condition is satisfied with a second predetermined time; and
operating, if the elapsed time is greater than the second predetermined time, the injector corresponding to the failed heater to inject fuel.

12. The method of claim 10, further comprising:
determining, when the plurality of heaters are operating, whether a heating release condition is satisfied; and
stopping, if the heating release condition is satisfied, operation of the plurality of heaters.

13. The method of claim 12, wherein the heating release condition is satisfied if the temperature of coolant is greater than or equal to the predetermined temperature.

14. The method of claim 12, wherein the heating release condition is satisfied if the heating time is greater than or equal to a threshold time.

15. The method of claim 10, wherein the plurality of heaters are mounted in the plurality of injectors, respectively.

16. The method of claim 10, wherein the plurality of heaters are mounted in a plurality of fuel supply lines supplying fuel to the plurality of injectors, respectively.

17. The method of claim 10, wherein the fuel comprises ethanol.
